(19) United States
(12) Patent Application Publication
(10) Pub. No.: US 2005/0220154 A1
(43) Pub. Date: Oct. 6, 2005

(54) Broadband mode-locked laser oscillator and oscillation method thereof

(75) Inventors: Sadao Uemura, Tsukuba-shi (JP); Kenji Torizuka, Tsukuba-shi (JP)

Correspondence Address: VENABLE LLP, P.O. BOX 34385, WASHINGTON, DC, 20045-9998, US

(73) Assignee: National Institute of Advanced Industrial Science and Technology, Tokyo (JP)

(21) Appl. No.: 11/086,757

(22) Filed: Mar. 23, 2005

(30) Foreign Application Priority Data
Mar. 24, 2004 (JP) 2004-086946

(51) Int. Cl. H01S 3/098

(52) U.S. Cl. 372/18

(57) ABSTRACT

A laser oscillator to further shorten a pulse width is provided by enabling broadband mode-locking even while using a laser medium having a precipitous fluorescence peak. A resonator has two concave mirrors and four chirped mirrors, and cavity-dispersion is compensated by these chirped mirrors. A semiconductor laser output is focused through a first concave mirror onto the laser medium to produce a gain medium in the resonator, whereby a laser oscillation is realized. While setting a target value in layer thickness design of dielectric multilayer of the chirped mirrors so as to slightly lower reflectivity at a fluorescence peak wavelength of the laser medium, fitting is redone, whereby reflectivity is slightly changed without greatly changing group-delay dispersion. In this procedure, reflectivity is reduced in any one or some of the chirped mirrors to average the gain.

This application claims priority from Japanese Patent Application No. 2004-086946 filed on Mar. 24, 2004 which is incorporated hereinto by reference.

### BACKGROUND OF THE INVENTION

1. Field of the Invention

The present invention relates to a broadband mode-locked laser oscillator using a laser medium having a precipitous fluorescence peak and a broadband mode-locked laser oscillation method.

2. Description of the Related Art

In order to generate an ultrashort light pulse, mode-locking has been generally employed. Mode-locking can be divided mainly into an actively mode-locking system for time-modulating gain and loss in a laser resonator by use of an external acousto-optic modulator or the like (FIGS. 1A and 1B) and a passively mode-locking system for automatically time-modulating the gain and loss by use of a semiconductor saturable absorber mirror, Kerr-lens effects of a laser medium or the like. The system using Kerr-lens effects has been in particular called a Kerr-lens mode-locking.

In FIGS. 1A to 1B and FIGS. 2A to 2D, A to F corresponds to respective configurations shown by a dashed rectangle in the drawing. Either component part A or B, either C or D, and either E or F are selectively used. The component part A shown in FIG. 1A is a scheme to carry out a dispersion compensation in a resonator by use of chirped mirrors 17 and 18, and the component part B shown in FIG. 1B is a scheme to carry out a dispersion compensation in the resonator by use of a prism pair 22 and 23.

FIG. 1A is a general layout drawing of an actively mode-locked laser, and the actively mode-locked laser comprises a semiconductor laser 10, a condenser lens 11, a first concave mirror 12, a laser medium 13, a second concave mirror 14, an acousto-optic modulator 15, an end mirror 16, the chirped mirrors 17 and 18, and an output mirror 24. The resonator is composed of the end mirror 16, the two concave mirrors 12 and 14, the two chirped mirrors 17 and 18, and the output mirror 24. An output of the semiconductor laser 10 is focused from the concave mirror 12 onto the laser medium 13 through the condenser lens 11 to produce a gain medium in the resonator, whereby a laser oscillation is realized. Herein, the whole mode-locked laser equipment is called the laser oscillator. Furthermore, a beam in the resonator is actively time-modulated by use of the acousto-optic modulator 15 and so forth to satisfactorily compensate intra-cavity dispersion by the chirped mirrors 17 and 18, and thereby an isochronic mode-locked pulse train can be obtained from the output mirror 24.

FIG. 1B is also a general schematic diagram of an actively mode-locked laser similarly to FIG. 1A, and this actively mode-locked laser uses a prism pair 22 and 23 in place of the chirped mirrors 17 and 18. With this configuration, by actively time-modulating a beam in the resonator by use of the acousto-optic modulator 15 and all to satisfactorily compensate intra-cavity dispersion by the prism pair 22 and 23, and then an isochronic mode-locked pulse train can be obtained from the output mirror 24.

FIGS. 2A to 2D are general layout drawings of a passively mode-locked laser, respectively. Although these passively mode-locked lasers are the same in the resonator configuration as the above-described actively mode-locked lasers, by incorporating a passive element such as a semiconductor saturable absorber mirror 26 (component part D) or by placing a slit 21 near the end mirror 19 (component part C) in case of Kerr-lens mode-locking, the resonator loss is automatically time-modulated. Since both lasers are designed so that the loss is lowered when peak power is higher, the pulse train gradually grows and the pulse width becomes narrower to a pulse width corresponded to a bandwidth of in-use mirrors and a degree of intra-cavity dispersion compensation. Apart of the pulse train is taken out of the output mirror 20 (component part E) or the output mirror 24 (component part F).

Ti:sapphire (titanium sapphire) is generally used as a femtosecond laser medium. As a femtosecond laser medium whose fluorescence curve is not smooth compared to that of Ti:sapphire, but also has a more precipitous fluorescence peak then Ti:sapphire, some Yb (Ytterbium) doped mediums, as a particularly notable example, Yb:YAG (Ytterbium-doped Yttrium Aluminum Garnet) can be mentioned. Herein, the “precipitous fluorescence peak,” means a fluorescence peak whose ratio between the full width at half maximum and central wavelength is equal to or less than approximately 0.05. The dashed curve in FIG. 3 shows the fluorescence curve of Yb:YAG (the value of the fluorescence can be read by the right-side vertical axis), which has the precipitous fluorescence peak at a wavelength of 1030 nm.

When a laser medium having a precipitous fluorescence peak such as Yb:YAG is used as a laser medium 13 shown in FIGS. 1A and 1B or FIGS. 2A to 2D to perform actively mode-locking or passively mode-locking, since high-gain wavelength regions are concentrated at a single point, a broadband mode-locked laser oscillation has been very difficult. Moreover, in this case, since the spectral width does not expand and the pulse width does not shorten, peak power of the pulse is small, therefore, it has been very difficult to implement Kerr-lens mode-locking. Consequently, for Yb:YAG lasers, as an example, the narrow-band laser oscillation whose spectrum is limited mainly to a fluorescence peak has been carried out by a mode-locking system except for Kerr-lens mode-locking. The pulse width of the oscillation is limited to approximately several hundred femtosecond, and in a case of a Yb:YAG passively mode-locked laser using a semiconductor saturable absorber mirror 26, for example, the shortest pulse width is 340 fs.

To develop a high power output mode-locked laser, use of a host material having excellent thermal properties is desirable, and accordingly, it become a future urgent need to develop a broadband mode-locking system less susceptible to a fluorescence curve of a laser medium. However, in prior art, when mode-locking is provided for a laser medium having a precipitous fluorescence peak (e.g., Yb:YAG,) since the gain at the fluorescence peak is considerably great compared to those across other wavelength regions, the mode-locked laser spectrum is limited in the vicinity of the peak, and then the pulse width has also been drastically limited.

### SUMMARY OF THE INVENTION

The present invention is implemented to solve the foregoing problems of the above-described conventional techniques. Therefore, for fabricating a high power output mode-locked laser oscillator used for laser processing and the like, it is an object of the present invention to select an optimum medium for a high power output laser from many kinds of laser media, then enable broadband mode-locking even with a narrow-band laser medium having a precipitous fluorescence peak, and further shorten the pulse width.

To accomplish the object, the present invention is mainly characterized by controlling reflectivity of a resonator mirror to average the gain performing a broadband mode-locked oscillation with a laser medium having a precipitous fluorescence peak. By this constructional feature, according to the present invention, it becomes possible to create, at a precipitous peak on a fluorescence wavelength-dependent curve of an active laser medium, a reflectivity loss on the resonator mirror so as to cancel out the peak to average the gain and thereby to perform a broadband the mode-locked oscillation.

More specifically, the broadband mode-locked laser oscillator according with the present invention averages the gain by lowering reflectivity at a fluorescence peak wavelength of a resonator mirror in a laser oscillator with a laser medium having a precipitous fluorescence peak, and thereby achieves broadband mode-locking. The gain averaging with the resonator mirror is carried out by varying and adjusting each layer thickness of a deposited multilayer of at least one of the mirrors composing the resonator mirror. Chirped mirrors of the resonator carry out gain averaging together with dispersion compensation in the resonator.

Separately from the resonator mirror to carry out the gain averaging, the dispersion compensation can be implemented by a prism pair. In addition, the gain averaging is performed by inserting a spectral filter having slight absorption at a fluorescence peak wavelength into the resonator or by inserting a spatial filter having slight absorption at the fluorescence peak wavelength into a position provided the fluorescence peak wavelength in a dispersion region of a prism pair, and also, the dispersion compensation is carried out by the prism pair or the chirped mirrors.

The above-mentioned mode-locking is performed by active mode-locking for time-modulating the gain and loss in a laser resonator by use of an external acousto-optic modulator and so forth, or by passive mode-locking for automatically time-modulating by use of a semiconductor saturable absorber mirror or Kerr lens effect of the laser medium.

In addition, a broadband mode-locked laser oscillation method according with the present invention averages the gain by lowering reflectivity at a fluorescence peak wavelength of the resonator mirror in the laser oscillation with a laser medium having a precipitous fluorescence peak, and thereby achieves broadband mode-locking.

By the above constructional features, according to the present invention, it becomes possible to provide broadband mode-locking even with a narrow-band laser medium having a precipitous fluorescence peak, therefore, when fabricating a high power output mode-locked laser oscillator to be used for laser processing and the like, it becomes possible to select an optimum medium for a high power output laser from many kinds of laser media, and furthermore, it becomes possible to further shorten a pulse width.

The above and other objects, effects, features, and advantages of the present invention will become more apparent from the following description of embodiments thereof taken in conjunction with the accompanying drawings.

### BRIEF DESCRIPTION OF THE DRAWINGS

FIGS. 1A to 1B are typical schematic diagrams showing a configuration of an actively mode-locked laser applicable to present invention, respectively;

FIGS. 2A to 2D are typical schematic diagrams showing a configuration of a passively mode-locked laser applicable to present invention, respectively;

FIG. 3 is a graph illustrating a fluorescence curve of Yb:YAG with a dashed line and a reflectivity of actually fabricated chirped mirrors 17 to 20 with a solid line;

FIG. 4 is a graph illustrating a spectrum of a Kerr-lens mode-locked Yb:YAG laser; and

FIG. 5 is a graph illustrating a spectrum of a passively mode-locked laser using a semiconductor saturable absorber mirror.

### DETAILED DESCRIPTION OF PREFERRED EMBODIMENTS

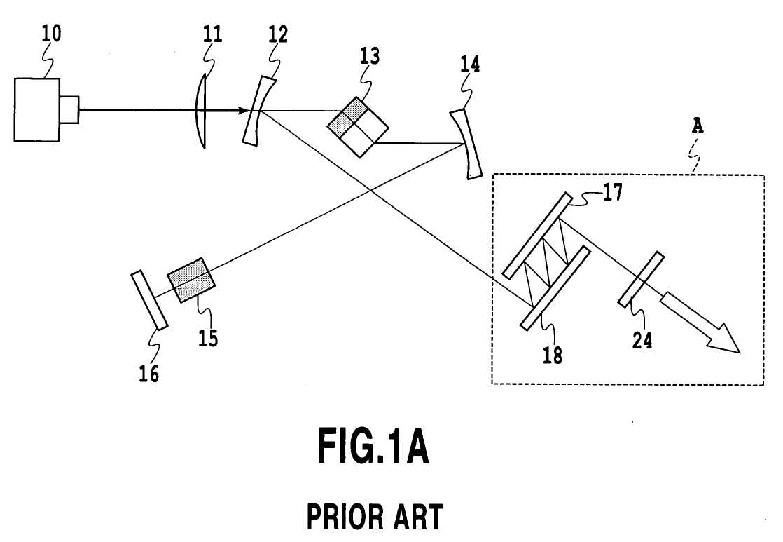

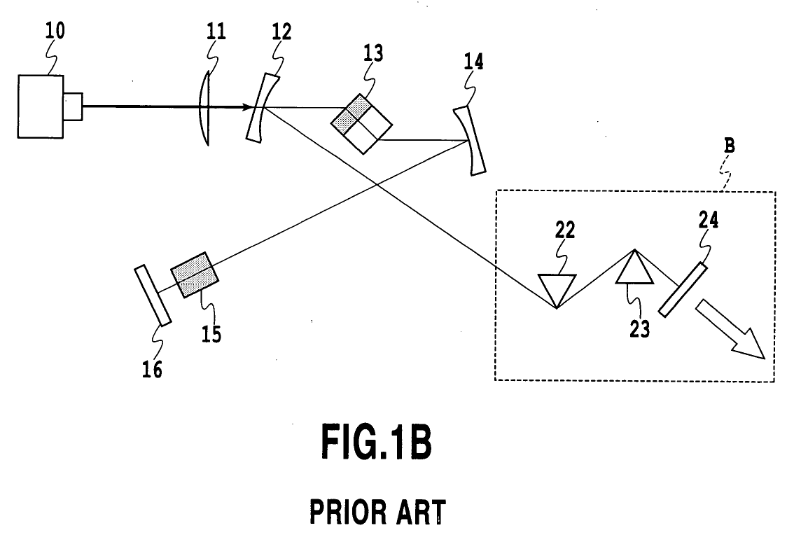

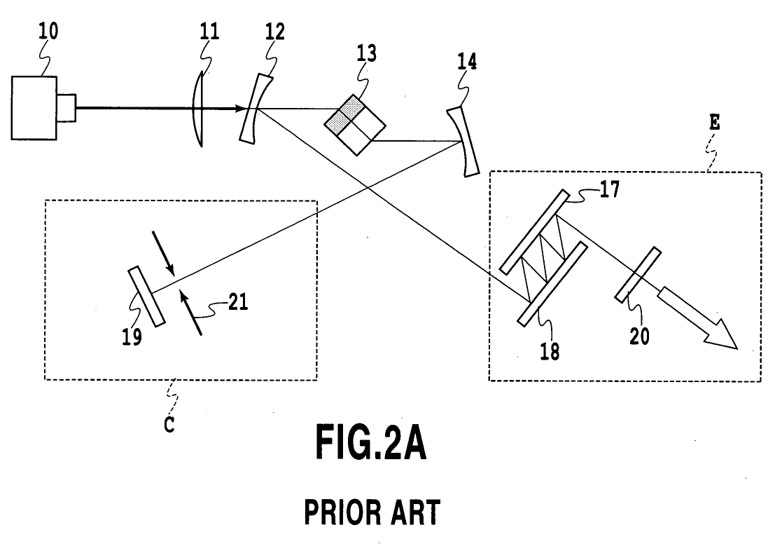

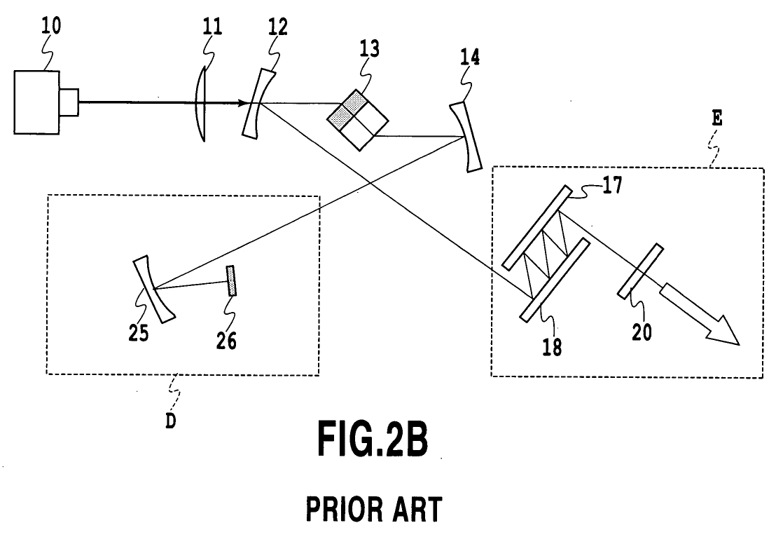

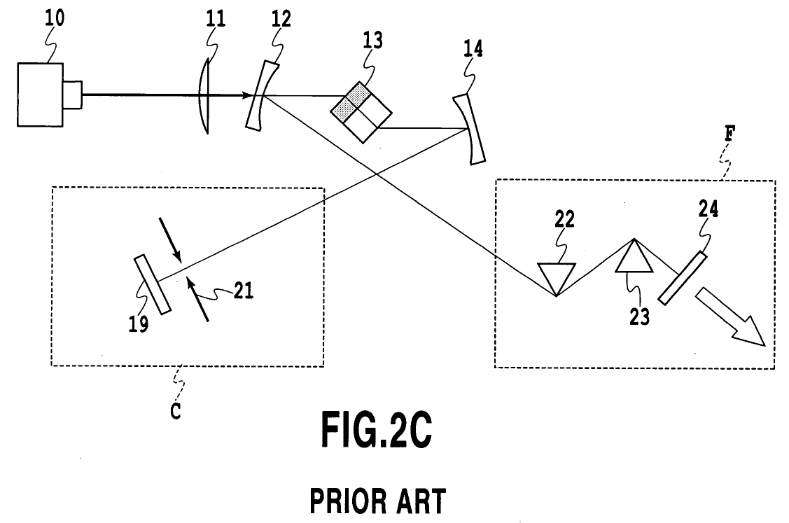

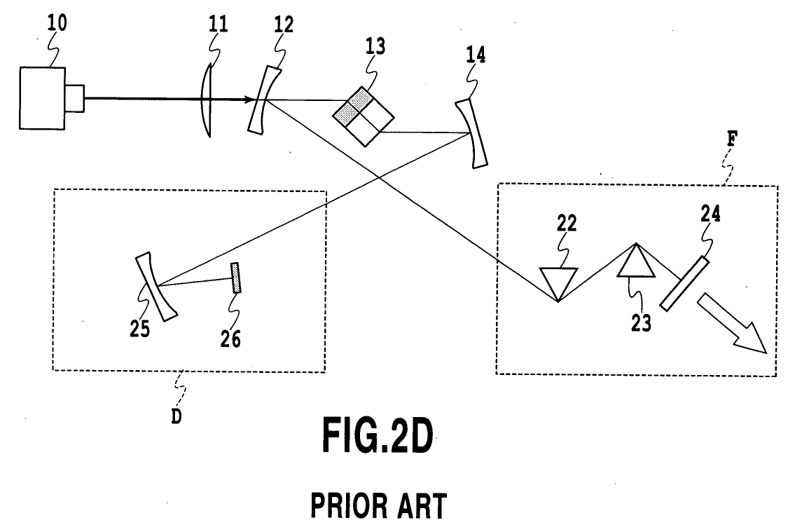

The configurations of a broadband mode-locked laser oscillator and a broadband mode-locked laser oscillation method according to the embodiments of the present invention will be described below with reference to the drawings. In respective following embodiments of the present invention, although the embodiments are applied the present invention to the mode-locked laser oscillators shown in FIGS. 2A, 2B, and FIG. 1A described in the related art paragraph, the present invention is not limited hereto and also may be applied to mode-locked laser oscillators with other arrangements, as well.

### First Embodiment

A first embodiment of the present invention will be described for a case where the present invention has been applied to a Kerr-lens mode-locked Yb:YAG laser oscillator shown in FIG. 2A. As shown in FIG. 2A, the broadband mode-locked laser oscillator comprises a semiconductor laser or laser diode 10, a condenser lens 11, a first concave mirror 12, a laser medium 13, a second concave mirror 14, a slit 21, a third chirped mirror 19, a first chirped mirror 17, a second chirped mirror 18, and a fourth chirped mirror 20. An output of the semiconductor laser 10 is focused on the laser medium 13 through the condenser lens 11 and the concave mirror 12 to produce a gain medium in the laser resonator, whereby the laser oscillation is realized. The laser beam passed through the laser medium 13 is reflected by the second concave mirror 14 and then is reflected by the third chirped mirror 19 after passing through the slit 21, and again follows the original optical path to return to the first concave mirror 12. The laser beam reflected by the concave mirror 12 and proceeded to the second chirped mirror 18 proceeds to the fourth chirped mirror 20 after repeating reflection more than once between the first chirped mirror 17 and the second chirped mirror 18. A part of the laser beam is transmitted through the fourth chirped mirror 20 and is outputted from the laser oscillator, and the rest is again reflected and follows the original optical path to return to the concave mirror 12.

As mentioned above, the laser resonator is composed of the two concave mirrors 12 and 14, four chirped mirrors 17 to 20, and laser medium 13. Herein, a set of the concave mirrors 12 and 14 and chirped mirrors 17 to 20 to perform a function to spatially confine light is called a resonator mirror. Dispersion in the resonator is compensated by the chirped mirrors 17 to 20.

The chirped mirrors 17 to 20 have been produced by a vapor-depositing multilayer of two types of dielectric materials (TiO₂ and SiO₂) on a glass substrates, wherein each layer thickness of the multilayer has been controlled so as to have a negative group-delay dispersion. In designing the layer thicknesses of the dielectric multilayer, fitting is redone while setting a target gain value so as to slightly lower reflectivity at a fluorescence peak wavelength (1030 nm) of Yb:YAG, whereby reflectivity is slightly changed without greatly changing group-delay dispersion. In actual fabrication, the vapor deposition is performed while controlling the layer thicknesses to an accuracy of approximately one angstrom. Reflectivity-lowered mirrors are not necessarily provided for all of four chirped mirrors 17 to 20, and it is also possible to reduce reflectivity in any one or several pieces of the mirrors in order to average the gain.

In the present, embodiment, although intra-cavity dispersion compensation and gain averaging by a reflectivity reduction are collectively performed by the chirped mirrors, these functions are also possible by assuming the roles of separate components, respectively. For example, even by only slightly changing the layer thicknesses of a popularized dielectric multilayer mirror (not shown) for ultrashort pulses lasers, mirrors whose reflectivity has been slightly reduced at a fluorescence peak wavelength can be simply produced without greatly changing properties of dispersion, therefore, the gain averaging can also be achieved by using the dielectric multilayer mirror for the resonator mirror and the dispersion compensation can carry out by means of the prism pair (the prisms 22 and 23 of FIGS. 2C and 2D). In addition, as the resonator, a resonator mirror (not shown) generally-used in an ultrashort pulse laser sets on, and the gain averaging can also be achieved by inserting a spectral filter (not shown) having a slight absorption at a fluorescence peak wavelength into the resonator, or by inserting a spatial filter (not shown) spatially having absorption only in part into a dispersion region of the prism pair (between the prism 23 and output mirror 24 in FIGS. 2C and 2D), and the dispersion compensation can also be achieved by means of the prism pair or chirped mirrors.

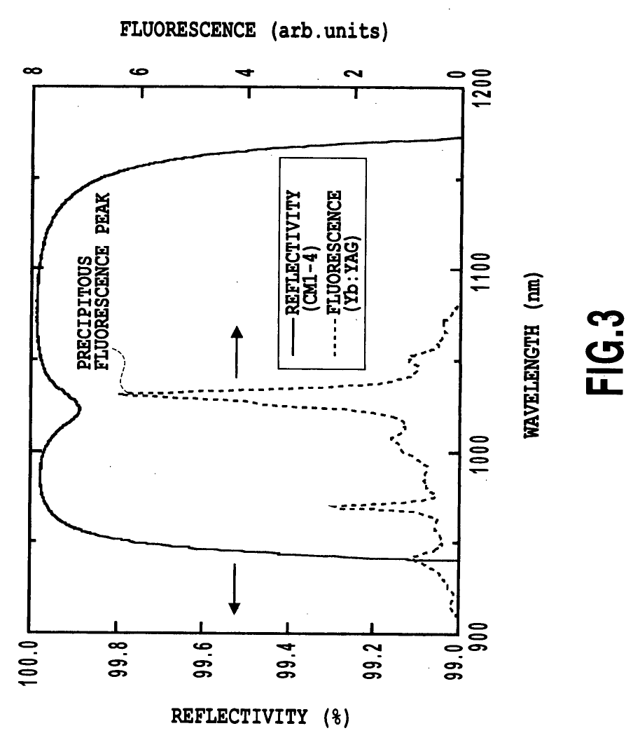

The solid line in FIG. 3 shows reflectivity of the actually fabricated chirped mirrors 17 to 20 (the value of the reflectivity can be read by the left-side vertical axis). The dashed line shows a fluorescence curve of Yb:YAG (the value of the fluorescence can be read by the right-side vertical axis). A reflectivity loss of the chirped mirrors exists in the vicinity of the peak of the Yb:YAG fluorescence curve so that the entire gain of the laser is averaged.

A perturbation is given to abeam in the resonator by placing the slit 21 near the third chirped mirror 19 and by vibrating the third chirped mirror 19 or fourth chirped mirror 20 which serves as an end mirror of the resonator, and an intra-cavity mode diameter is changed by Kerr-lens effects which occur in the laser medium 13, whereby an intra-cavity loss is automatically time-modulated by the slit 21. Since the position of the silt 21 is set so that the loss is lowered when peak power is high, a pulse train gradually grows and is made into a short pulse with a pulse width corresponding to the bandwidth of used mirrors or the degree of intra-cavity dispersion compensation. Apart of the pulse train is taken out of the output mirror composed of the chirped mirror 20.

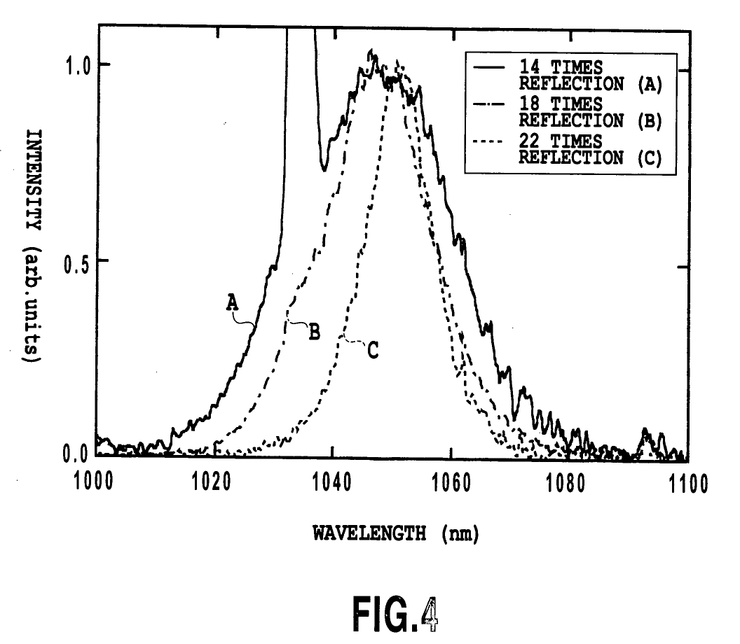

FIG. 4 shows a spectrum of a Kerr-lens mode-locked Yb:YAG laser, wherein the solid curve A, alternate long and short dashed curve B, and dashed curve C are spectra when reflection bounce numbers of the chirped mirrors per one round trip in the resonator is 14 times, 18 times, and 22 times, respectively. These reflection bounce numbers are obtained when the number of points of reflection of the respective chirped mirrors 17 and 18 shown in FIG. 2A is set to 3 points, 4 points, and 5 points by changing the incident angle of the chirped mirrors 17 and 18. Changing the reflection bounce number of the chirped mirrors from 22 to 14, the spectral width of the mode-locked laser was gradually expanded and finally reached 30 nm (FWHM). When the reflection bounce number was 10 times, Kerr-lens mode-locking was not successfully provided. An optimum reflection bounce number in this experiment is 14 times, and the pulse width at this time is equivalent to 38 fs when a Fourier-transform limited sech-shaped pulse is assumed. In the laser medium Yb:YAG having the precipitous fluorescence peak, broadband mode-locking was achieved by employing the present method.

### Second Embodiment

Next, a second embodiment of the present invention will be described for a case where the invention has been applied to a passively mode-locked Yb:YAG laser oscillator using the semiconductor saturable absorber mirror 26 shown in FIG. 2B. The configuration of FIG. 2B is the above-described configuration of FIG. 2A wherein the component part C has been replaced with a component part D. Namely, one end mirror of the resonator is replaced with a concave mirror 25, and the laser beam is focused onto the semiconductor saturable absorber mirror (SESAM) 26 to perform laser oscillation by a passively mode-locking method. Herein, a set of the concave mirrors 12, 14, and 25, the chirped mirrors 17 and 18, the chirped mirror 20, and the semiconductor saturable absorber mirror 26 is called a resonator mirror.

The chirped mirrors 17, 18, and 20 have been produced by vapor-depositing layers of two types of dielectric materials (TiO₂ and SiO₂) on glass substrates, wherein, in order to compensate dispersion in the resonator, the layer thicknesses of the multilayer have been controlled so as to have a negative group-delay dispersion. In designing the layer thicknesses of the dielectric multilayer, fitting is redone while further setting a target gain value so as to slightly lower reflectivity at a fluorescence peak wavelength (1030 nm) of Yb:YAG, whereby the reflectivity is slightly changed without greatly changing group-delay dispersion. In actual fabrication, the vapor deposition is performed while controlling the layer thicknesses to an accuracy of approximately one angstrom. Reflectivity-lowered mirrors are not necessarily provided for all of chirped mirrors, and it is also possible to reduce reflectivity in one of or two mirrors so as to average the gain.

The solid line in FIG. 3 shows reflectivity of the actually fabricated chirped mirrors (the value of the reflectivity can be read by the left-side vertical axis). The dashed line shows a fluorescence curve of Yb:YAG (the value of the fluorescence can be read by the right-side vertical axis). A reflectivity loss of the chirped mirrors exists in the vicinity of the peak of the Yb:YAG fluorescence curve so that the entire gain of the laser is averaged.

In the present embodiment, although intra-cavity dispersion compensation and gain averaging by a reflectivity reduction are collectively performed by the chirped mirrors 17, 18, and 20, these functions are also possible by assuming the roles of separate components, respectively. For example, even by only slightly changing layer thicknesses of a popularized dielectric multilayer mirror (not shown) for ultrashort pulse lasers, mirrors whose reflectivity has been slightly reduced at a fluorescence peak wavelength can be simply produced without greatly changing properties of dispersion, therefore, the gain averaging can also be achieved by using the dielectric multilayer mirror for the resonator mirror and dispersion compensation carry out by means of the prism pair (the prisms 22 and 23 of FIGS. 2C and 2D). In addition, as the resonator mirrors, ones (not shown) generally-used in an ultrashort pulse laser set on and the gain averaging can also be achieved by inserting a spectral filter (not shown) having a slight absorption at a fluorescence peak wavelength into the resonator, or by inserting a spatial filter (not shown) having absorption only in part spatially into a dispersion region of the prism pair (between the prism 23 and output mirror 24 in FIGS. 2C and 2D,) and the dispersion compensation can also be achieved by means of the prism pair or chirped mirrors.

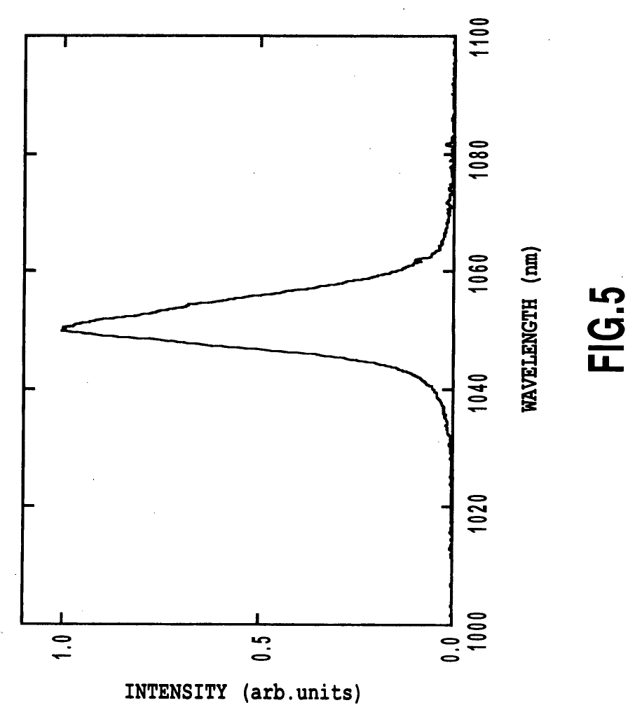

FIG. 5 shows a spectrum of a passively mode-locked laser using the semiconductor saturable absorber mirror 26, whose spectral width is 9.2 nm, and the pulse width is equivalent to 126 fs when a Fourier-transform limited sech-shaped pulse is assumed. By employing the present method, the pulse width was further shortened compared with that of general narrow-band passive mode-locking.

### Third Embodiment

Next, a third embodiment of the present invention will be described for a case where the invention has been applied to an actively mode-locked Yb:YAG laser oscillator using the acousto-optic modulator 15 shown in FIG. 1A. Herein, a set of the concave mirrors 12 and 14, the chirped mirrors 17 and 18, the end mirror 16, and the output mirror 24 is called a resonator mirror.

The chirped mirrors 17 and 18 have been produced by vapor-depositing layers of two types of dielectric materials (TiO₂ and SiO₂) on glass substrates, wherein, in order to compensate dispersion in the resonator, the layer thicknesses of the multilayer have been controlled so as to have a negative group-delay dispersion. In designing the layer thicknesses of the dielectric multilayer, fitting is redone while further setting a target gain value set so as to slightly lower reflectivity at a fluorescence peak wavelength (1030 nm) of Yb:YAG, whereby the reflectivity is slightly changed without greatly changing group-delay dispersion. In actual fabrication, the vapor deposition is performed while controlling the layer thicknesses to an accuracy of approximately one angstrom. Mirrors for lowering reflectivity are not necessarily provided for all of chirped mirrors, and it is also possible to reduce reflectivity in either mirror so as to average the gain.

The solid line in FIG. 3 shows reflectivity of the actually fabricated chirped mirrors (for reflectivity, the leftward vertical axis is read). The dashed line shows a fluorescence curve of Yb:YAG (for fluorescence, the rightward vertical axis is read). A reflectivity loss of the chirped mirrors exists in the vicinity of the peak of the Yb:YAG fluorescence curve so that the entire gain of the laser is averaged.

In the present embodiment, although intra-cavity dispersion compensation and gain averaging by a reflectivity reduction are collectively performed by the chirped mirrors, these functions are also possible by assuming the roles of separate components, respectively. For example, even by only slightly changing a layer thicknesses of popularized dielectric multilayer mirror (not shown) for an ultrashort pulse lasers, mirrors whose reflectivity has been slightly reduced at a fluorescence peak wavelength can be simply produced without greatly changing properties of dispersion, therefore, the gain averaging can also be achieved by using the dielectric multilayer mirror for the resonator mirror and dispersion compensation carry out by means of the prism pair. In addition, as the resonator mirrors, ones (not shown) generally-used in an ultrashort pulse laser set on and the gain averaging can also be achieved by inserting a spectral filter (not shown) having a slight absorption at a fluorescence peak wavelength into the resonator, or by inserting a spatial filter having absorption only in part spatially into a dispersion region of the prism pair (between the prism 23 and output mirror 24 in FIG. 1B), and the dispersion compensation can also be achieved by means of the prism pair or chirped mirrors. In the actively mode-locked laser as well, the realization of a broadband mode-locked laser oscillation can be expected by the present method by which the entire gain of the laser is averaged.

### Other Embodiments

Although the invention has been applied to the configuration shown in FIG. 2A in the above-described first embodiment of the present invention, similar thereto, the invention can also be applied to the configuration shown in FIG. 2C. In addition, although the invention has been applied to the configuration shown in FIG. 2B in the second embodiment of the present invention, similar thereto, the invention can also be applied to the configuration shown in FIG. 2D. Furthermore, although the invention has been applied to the configuration shown in FIG. 1A in the third embodiment of the present invention, similar thereto, the invention can also be applied to the configuration shown in FIG. 1B.

The present invention has been described by way of example of preferred embodiments. However, the embodiments in accordance with the present invention are not limited to the foregoing examples, and a variety of modifications such as replacement, changes, addition, increase or decrease in the number, or the changes in the geometry of the components of the configuration are all included in the embodiments in accordance with the present invention as long as they fall within the scope of the claims.

1. A broadband mode-locked laser oscillator using a laser medium having a precipitous fluorescence peak, wherein
gain is averaged by lowering reflectivity at a fluorescence peak wavelength of a resonator mirror, whereby broadband mode-locking is achieved.

2. The broadband mode-locked laser oscillator as claimed in claim 1, wherein
the gain averaging in the resonator mirror is carried out by varying layer thicknesses of a deposited multilayer of at least one of a plurality of mirrors composing the resonator mirrors.

3. The broadband mode-locked laser oscillator as claimed in claim 2, wherein
a plurality of chirped mirrors composing the resonator carry out the gain averaging together with dispersion compensation in the laser resonator.

4. The broadband mode-locked laser oscillator as claimed in claim 1, wherein
the gain averaging in the resonator mirror is performed by inserting a spectral filter having absorption at a fluorescence peak wavelength into the laser resonator, or by inserting a spatial filter having absorption at the fluorescence peak wavelength into a position provided the fluorescence peak wavelength in a dispersion region of a prism pair in the laser resonator.

5. The broadband mode-locked laser oscillator as claimed in claim 4, wherein
separately from the resonator mirror for performing the gain averaging, the dispersion compensation in the laser resonator is implementing by means of a prism pair or chirped mirrors.

6. The broadband mode-locked laser oscillator as claimed in claim 1, wherein
the mode-locking is performed either by active mode-locking for time-modulating gain and loss in a laser resonator by use of an external acousto-optic modulator, or by passive mode-locking for automatically time-modulating by use of a semiconductor saturable absorber mirror or Kerr lens effect of the laser medium.

7. A broadband mode-locked laser oscillation method using a laser medium having a precipitous fluorescence peak, wherein
gain is averaged by lowering reflectivity at a fluorescence peak wavelength of at least one of the resonator mirrors, whereby broadband mode-locking is achieved.
